(19) United States
(12) Patent Application Publication
(10) Pub. No.: US 2017/0061511 A1
(43) Pub. Date: Mar. 2, 2017

(54) MOBILE DEVICE INITIATED CONCIERGE EXPERIENCE

(71) Applicant: Comenity LLC, Columbus, OH (US)

(72) Inventors: Ramesh KORRA, Hilliard, OH (US); Adam KOLTNOW, Worthington, OH (US); Christian BILLMAN, Blacklick, OH (US); Uchenna CHILAKA, Gahanna, OH (US)

(73) Assignee: Comenity LLC, Columbus, OH (US)

(21) Appl. No.: 15/244,401

(22) Filed: Aug. 23, 2016

Related U.S. Application Data
(60) Provisional application No. 62/212,167, filed on Aug. 31, 2015.

(51) Int. Cl. G06Q 30/06; H04W 4/04; H04W 4/02

(52) U.S. Cl. CPC G06Q 30/0613; H04W 4/021; H04W 4/04

(57) ABSTRACT

A method and system for providing a mobile device initiated concierge experience is disclosed. The concierge experience determines that a mobile device is within an area of interest. The concierge experience interacts with the mobile device to determine an identifying characteristic. A database is searched for a customer profile related to the identifying characteristic. When the customer profile is identified, the customer profile is provided to a store associate's mobile device, wherein the customer profile is utilized by the store associate to positively identify a user of the mobile device and provide the user with a personalized shopping experience.

This application claims priority to and benefit of co-pending U.S. Provisional Patent Application No. 62/212,167 filed on Aug. 31, 2015, entitled “MOBILE DEVICE INITIATED CONCIERGE EXPERIENCE” by Adam Koltnow et al., and assigned to the assignee of the present application, the disclosure of which is hereby incorporated herein by reference in its entirety.

### BACKGROUND

Presently, when a customer enters a store, there is likely no personalized recognition of the event. Sellers rely on shelf locations, hanging signs and the like to try and provide a customer with a sense of situational awareness and encourage the customer to make a purchase. Moreover, if a customer does need assistance, it can sometimes be difficult for the customer to find assistance which can easily result in customer frustration and departure from the store without making a purchase.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram of a mobile device concierge system, in accordance with an embodiment.

FIG. 2 is a flow chart of a method for providing a mobile device initiated concierge experience, in accordance with an embodiment.

FIG. 3 is a block diagram that illustrates an embodiment of a retail establishment wherein the mobile device initiated concierge experience may occur in accordance with an embodiment.

FIG. 4A is a block diagram of a mobile device initiated concierge experience as viewed on an associate's mobile device, in accordance with an embodiment.

FIG. 4B is a block diagram of another level of the mobile device initiated concierge experience as viewed on an associate's mobile device, in accordance with an embodiment.

FIG. 4C is a block diagram of yet another level of the mobile device initiated concierge experience as viewed on an associate's mobile device, in accordance with an embodiment.

FIG. 5 is a block diagram of an example computer system with which or upon which various embodiments of the present invention may be implemented.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “selecting”, “outputting”, “inputting”, “providing”, “receiving”, “utilizing”, “obtaining”, “updating”, “accessing”, “changing”, “deciding”, “determining”, “interacting”, “searching”, “pinging” or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

### Overview

A mobile device initiated concierge experience is discussed herein. In one embodiment, a customer's mobile device provides identifying information to a store's concierge experience. The identifying information is used by the store to access a customer's profile. The profile is provided to a store associate, via the associate's mobile device, the store's point of sale (POS) system, the store's mobile device or the like, such that the store associate can provide a personalized shopping experience to the customer.

For example, when a customer with a mobile device about their person approaches or is within a pre-defined vicinity of a store, the concierge experience will interact with the customer's mobile device to obtain an identifier. The concierge experience will access a database and use the identifier to obtain a customer profile associated therewith. The concierge experience will provide the customer profile to a store associate. Again, and throughout the following discussion, the customer profile can be provided to the store associate via the associate's mobile device, the store's POS, or the like.

Therefore, when the customer enters the store, the store associate will either receive or have already received the customer's profile. Included in the customer profile will be identifying information such as a picture, a description, or the like. Included in the profile will also be some amount of historical information related to the customer. The associate will be able to utilize the customer profile to approach the customer and provide a personalized greeting, such as, “Hello Jim, welcome back.” Moreover, the associate can utilize the historical information to further help Jim ascertain his shopping needs, provide size information, etc.

It should be appreciated that the obtaining or accessing of user information conforms to applicable privacy laws (e.g., federal privacy laws, state privacy laws, etc.).

### Operation

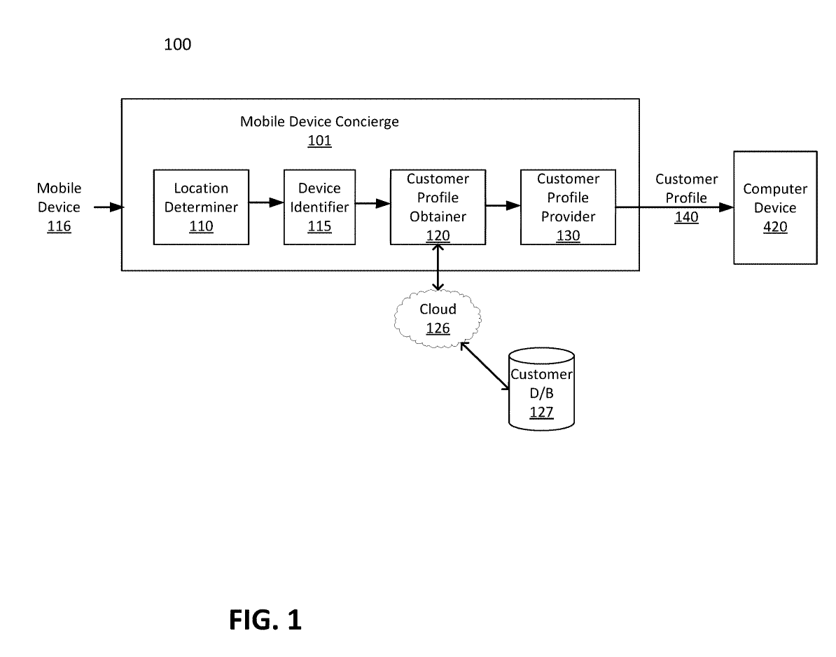

Referring now to FIG. 1, a block diagram of a mobile device concierge system 100 is shown in accordance with an embodiment. In one embodiment, mobile device concierge system 100 includes a mobile device 116, a mobile device concierge 101, a customer profile 140, a computer device 420, cloud 126 and customer database 127. Although a number of applications and components are shown in mobile device concierge system 100, it should be appreciated that the components and applications may be located separately from one another. For example, one or more of the components and applications may be found on one or more locations, such as, but not limited to a computer in the retail store, a server at a remote location, on the cloud 126, in customer database 127 or the like.

An example of cloud 126 is a network such as the Internet, local area network (LAN), wide area network (WAN), or the like. Customer database 127 is a database that includes customer profile information. Database 127 may be store specific, retailer specific, company specific, a shared database, a conglomerate database, a portion of a larger storage database, and the like. Moreover, the database could be a local database, a virtual database, a cloud database or a combination thereof.

For purposes of the following discussion, mobile device 116, and similarly store associate's computer device 420 (if computer device 420 is a mobile computer device and not a POS system), may be a mobile phone, a smart phone, a tablet, a smart watch, a piece of smart jewelry, smart glasses, or other user portable devices having wireless connectivity. That is, the mobile device would be capable of broadcasting and receiving via at least one network, such as, but not limited to, WiFi, Cellular, Bluetooth, NFC, and the like. In one embodiment, the mobile device may have a positioning determining system. In another embodiment, the mobile device may be able to determine location within a given radius, such as the broadcast range of a beacon, WiFi hotspot, overlapped area covered by a plurality of mobile telephone signal providers, or the like.

In one embodiment, customer profile 140 may include a picture, a purchase history, important dates for the customer, e.g., birthday, anniversary, relative's birthday, friend/family registry information, likes, dislikes, presence of existing offers including discounts, rewards or credit approvals, etc. In one embodiment, customer profile 140 may be generated by the user's purchase history, by associate provided input, or by user provided input. For example, a customer may provide important dates, likes and dislikes, etc. on the shop's application, or the like to develop a more personal shopping experience. Similarly, a store associate may provide information about a customer after a purchase. Such as, married/single, likes/dislikes, planned travel, type of work, etc.

In one embodiment, mobile device concierge 101 includes a location determiner 110, a device identifier 115, a customer profile obtainer 120 and a customer profile provider 130. Although a number of applications and components are shown, it should be appreciated that there may be more of fewer components and applications within mobile device concierge 101. Moreover, different pieces may be combined, re-organized, located separately from one another, or the like. The present structural breakdown is provided for purposes of clarity.

In one embodiment, location determiner 110 monitors an area of interest and determines if a mobile device 116 enters into the area of interest. This determination may be made by, but is not limited to: a pinging of mobile device 116, a push or pull interaction with a beacon, a location broadcast from mobile device 116, a location broadcast from an app, such as a store's application, operating on mobile device 116, mobile device 116 entering into a geo-fenced area, connection to a WiFi network, and the like. Moreover, the location broadcast may be an actual location or a relative location broadcast. For example, if mobile device 116 is equipped with a GPS, the location information may be specific latitude and longitude. In contrast, if a beacon is used, then the location of mobile device 116 would be as broad as within range of the beacon, within a geo-fenced area, and the like. In one embodiment, location determiner will interact with mobile device 116.

In general, device ID 115 obtains an identifier for mobile device 116 that allows a distinct user to be recognized. For example, the device ID 115 could obtain a phone number of mobile device 116, a SIM card integrated circuit card identifier (ICCID) for mobile device 116, a unique device identifier (UDID) for mobile device 116, a user's name, a user's store account number, a user's store rewards number, a user identifier provided by an application on mobile device 116, or the like.

In one embodiment, customer profile obtainer 120 utilizes the identifier for mobile device 116 to search customer database 127 for an associated customer profile. In one embodiment, the search of customer database 127 may be a local search, over cloud 126, or the like. The use of cloud 126 as the route for accessing customer database 127 as shown in FIG. 1 is provided for purposes of clarity.

In general, customer profile provider 130 provides customer profile 140 to store associate via computer device 420. Customer profile provider 130 would be capable of broadcasting via at least one network, such as, but not limited to, WiFi, Cellular, Bluetooth, NFC, and the like.

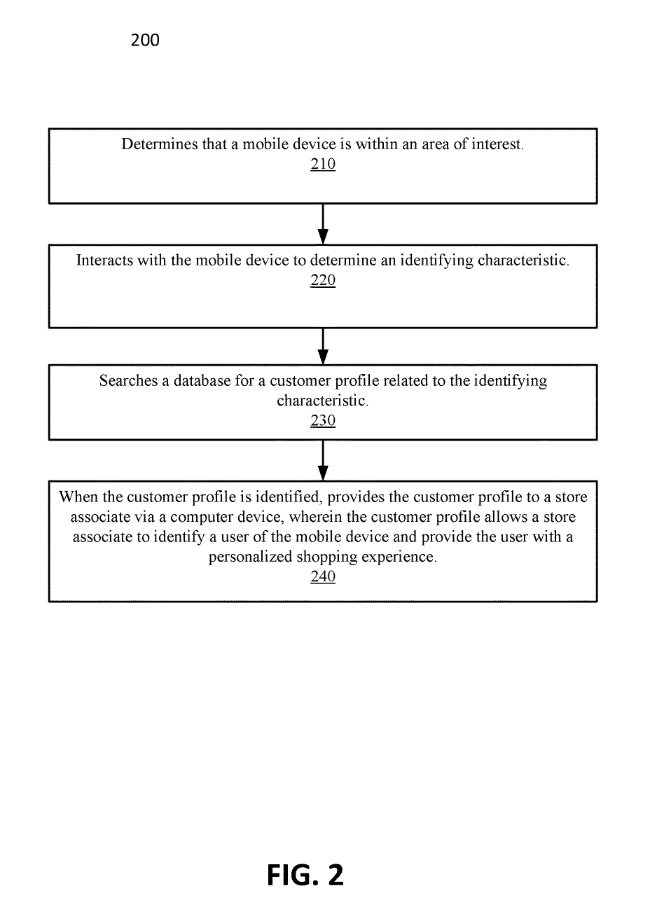

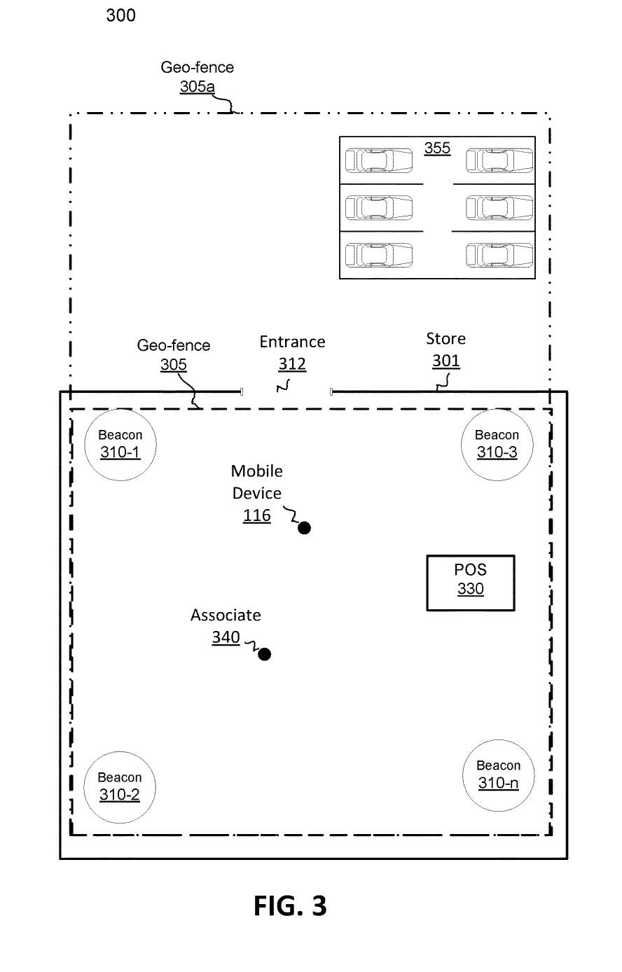

With reference now to FIG. 2, a flowchart 200 of a method for providing a mobile device initiated concierge experience is shown in accordance with an embodiment. In the following discussion, FIG. 3 is also utilized to provide clarity and support for the discussion of flowchart 200.

FIG. 3 provides a top plan view 300 of a retail store 301 is shown in accordance with an embodiment. In general, retail store 301 is any physical brick and mortar store that provides goods for sale at the store location. In one embodiment, retail store 301 includes an entrance 312. In addition, in different embodiments and configurations, retail store 301 can include one or more of, geo-fence 305, geo-fence 305a, beacons 310-1 through 310-n, point of sale (POS) 330, and exterior space such as a parking lot 355.

For purposes of the discussion, geo-fence 305 and geo-fence 305a refer to a virtual perimeter defining a real-world geographic area. Moreover, geo-fence 305 and geo-fence 305a can be created by various means, one of which includes the use of beacons. For example, in FIG. 3, geo-fence 305 is a rectangle created by the physical locations of beacons 310-1, 310-2, 310-3, and 310-n that includes the area at a boundary about store 301. In contrast, geo-fence 305a includes the area at a boundary about store 301, a parking lot 355 another part of a mall in which the store is located, and the like. It should be appreciated that geo-fence 305 and geo-fence 305a can be a number of different sizes and shapes.

Further, the one or more of beacons 310-1 through 310-n are devices configured to be communicatively coupled with mobile device 116, such as via near field communication (NFC), Bluetooth, WiFi, or the like. In one embodiment, one or more of beacons 310-1 through 310-n is an iBeacon™, which is an indoor positioning system from Apple Inc. For example, the iBeacon is a low-powered, low-cost transmitter that can notify nearby iOS and/or Android devices of their presence. Although an iBeacon is provided as a specific example, the beacons are not limited to only that brand. Different beacons from other companies would also likely be acceptable.

Referring now to 210 of FIG. 2 and to FIG. 3, one embodiment determines that a mobile device is within an area of interest. As discussed herein, the location of mobile device 116 can be provided by the mobile device or can be determined via geo-fence, beacon range, a ping, NFC, WiFi, or the like. Moreover, the location may be an actual location or a relative location.

Actual location information may be obtained by the user's mobile device location services, such as but not limited to, GPS, WiFi, cellular service, beacon derived location determination and the like. Moreover, the location determined by the mobile device location service may be useful even at differing levels of accuracy. For example, a GPS enabled mobile device 116 can provide location information that is accurate to within a few meters while a cellular service, beacon or WiFi location capabilities of mobile device 116 can provide a location radius or location area. For example, the mobile device 116 being located within range of a beacon, within the overlapping area of a number of cellular service towers, etc.

In contrast, relative location information can be determined via a beacon such as one or more of beacons 310-1 through 310-n. For example, although the actual location of mobile device 116 may not be known, if mobile device 116 were interacting with beacon 310-1, then the relative location of mobile device 116 would have to be near, or in range of, beacon 310-1 broadcast capabilities. Similarly, a geo-fence could be used to determine that mobile device 116 is within the geo-fenced area.

In one embodiment, an application on mobile device 116 will be enabled to look for the transmission of one or more of beacons 310-1 through 310-n. When mobile device 116 is within physical proximity to the beacon and detects it, the application can notify mobile device concierge 101.

With reference now to 220 of FIG. 2 and to FIG. 3, one embodiment interacts with the mobile device to determine an identifying characteristic. As described herein, the identifying characteristic should be a unique identifier. For example, the identifying characteristic may be, but is not limited to: a mobile device phone number, a mobile device identifier such as: a SIM card integrated circuit card identifier (ICCID) or a unique device identifier (UDID), a user's name, a user's store account number, a user's store rewards number, and a user identifier provided by an application operating on the mobile device.

Referring now to 230 of FIG. 2 and to FIG. 3, one embodiment searches a database for a customer profile related to the identifying characteristic. For example, customer database 127 is a database that includes customer profile information. In general, the database may be a local database, a virtual database, a cloud database or a combination thereof. In one embodiment, the customer profile information stored within customer database 127 will be associated with the identifying characteristic received from mobile device 116.

For example, if the identifying characteristic is a mobile phone number, customer profile obtainer 120 would search the customer profile information of customer database 127 using the phone number from mobile device 116 as the search query. If a customer profile is identified as being associated with that mobile phone number, customer profile obtainer 120 would obtain the associated customer profile.

With reference now to 240 of FIG. 2 and to FIG. 3, when the customer profile is identified, one embodiment provides the customer profile to a store associate 340 via a computer device 420, wherein the customer profile is utilized by a store associate 340 to identify a user of the mobile device 116 and provide the user with a personalized shopping experience. In one embodiment, computer device 420 is one or more of an associate's mobile device, the store's POS 330, a store's mobile device, and the like.

In one embodiment, customer profile 140 is provided to store associate via computer device 420 after the user's mobile device 116 enters into the area defined by geo-fence 305. In yet another embodiment, customer profile 140 is provided to store associate via computer device 420 when a location capability of the mobile device determines that the mobile device 116 is located near retail store 301. In general, near retail store 301 refers to a location such as, within the bounds of the store, within a few yards of the store, within the mall in which store 301 is located, within a beacon or WiFi broadcast range of store 301, at a parking lot 355 associated with the retail store 301, or the like.

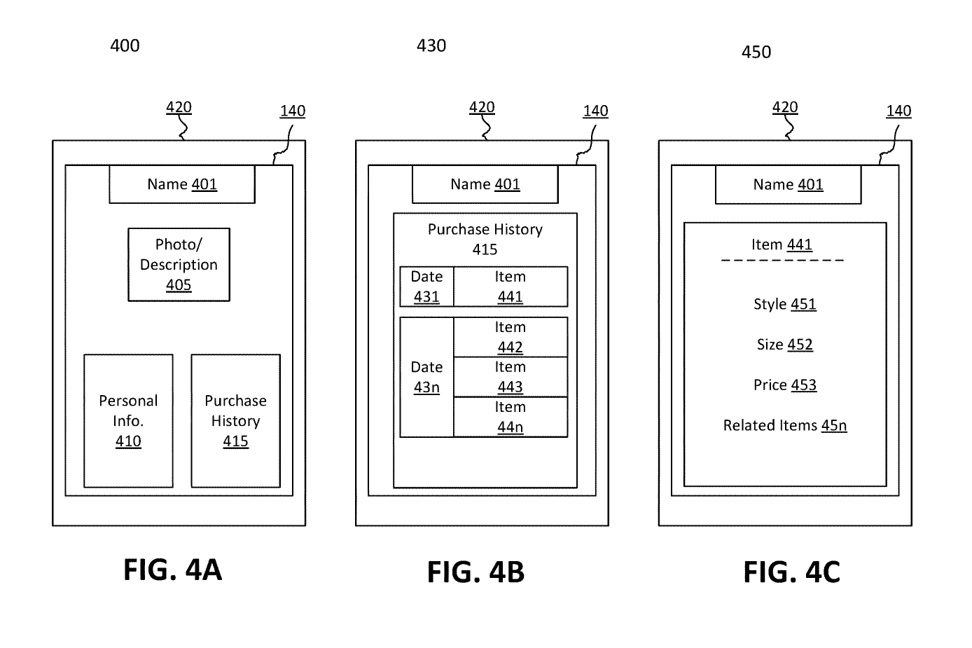

As described in more detail in FIGS. 4A-C and its associated discussion, customer profile 140 may include customer information such as, but not limited to or inclusive of, a user's picture, a user's description, a user's name, a user's store account number, a user's store rewards number, a purchase history, an important date for the user, and the like. In one embodiment, additional information may also be provided based on customer tracking while in the store. Information such as where the customer goes in the store, where the customer stops, slows, or the like. That is, by knowing the portion of the store mostly visited by the customer, information about what the customer is looking for may be deduced. For example, if the customer had previously purchased dress pants, and she is now in the shirt section, the associate may be able to provide a recommendation to the customer about a shirt that would go with the pants.

Once associate 340 receives the user profile, the store associate can utilize the user' picture or physical description to identify the user entering store 301. Associate 340 can then approach the customer and provide a personalized greeting such as, “Good Afternoon Steve.” The associate can then continue to utilize information provided by the customer and information available in the customer profile to provide the customer with a personalized shopping experience.

In one embodiment, the identifying characteristic may result in more than one customer profile being identified in 230. For example, a recycled phone number, a recycled mobile device 116, or more than one customer being associated with a phone number. If there were only a handful, e.g., less than 10-20 identified customer profiles, customer profile obtainer 120 would provide each of the identified customer profiles.

In this situation, each of the identified customer profiles would be provided to the store associate via computer device 420 and the store associate would then be able to determine the appropriate customer based on the customer description associated with the customer profiles. For example, if a mobile device phone number returned a family of father, mother, daughter and son, the associate would be able to look at the customer entering the store 301 and then flip through each of the customer profiles until the appropriate customer was identified. For example, if it was daughter who was on Dad's mobile phone, the associate would be able to quickly ascertain that it was not Dad but instead daughter entering the store. The associate would then select the daughter's customer profile and provide the daughter with the personalized shopping experience.

However, if the number of related identified customer profiles is too large, e.g., more than a predefined number, in one embodiment, the customer profile obtainer 120 would not provide any of the identified customer profiles to store associate via computer device 420.

In another embodiment, mobile device 116 may be in the parking lot 355 (or street, or other portion of a shopping center) that is within range of store 301, such as within geo-fence 305a. Since a customer profile has been obtained, the customer profile provider 130 or computer device 420 may decide to provide a shopping incentive offer or store visit incentive to mobile device 116 to inspire the user to stop into store 301. For example, the offer may be a coupon, a discount, a sales advert, a friendly hello, or the like. Moreover, the offer may be delivered or broadcast to mobile device 116 via a method such as, but not limited to, a beacon broadcast, WiFi broadcast, email, text message, SMS, social media alert, app alert, a notification from a store's application operating on the mobile device, or the like.

Referring now to FIG. 4A, a block diagram 400 of a mobile device initiated concierge experience as viewed on computer device 420 is shown in accordance with an embodiment.

In diagram 400, an overview of one example format of a customer profile 140 is shown as displayed on computer device 420. Although a number of different types of information are displayed on each of the screens shown in FIGS. 4A-4C, it should be appreciated that the information displayed at any level may be different in type, organization, layout, or the like. The following layouts are provided for purposes of clarity.

At diagram 400, an embodiment of an overview page for customer profile 140 is shown. This page includes a name 401, a photo or description 405, personal information selectable 410 and a purchase history selectable 415. In general, the overview page is useful for the associate 340 to ensure that they are contacting the correct customer. For example, the associate can look at the photo or read the description and then positively identify the customer. The associate 106 can further use the name information to initiate contact while addressing the customer by name. The two additional selectables, e.g., personal information selectable 410 and purchase history selectable 415, allow the associate to drill down into additional levels of detail as the personalized shopping experience progresses.

For example, diagram 400 would be a useful tool to welcome a customer to the store. Associate 340 would provide a personalized welcome close to or at the time the customer enters the store and begins a helpful and intimate dialogue.

With reference now to FIG. 4B, a block diagram 430 of another level of the mobile device initiated concierge experience as viewed on computer device 420 is shown in accordance with an embodiment. For example, once associate 430 has made the initial contact, it may be determined that the customer's purchase history should be further investigated. This determination may be based on a customer request or on an associates own initiative. At 430, the associate has selected the purchase history selectable 415. In one embodiment, that selection results in a screen that includes a display of dates 431-43n and associated items 441-44n purchased on those dates.

For example, on date 431 the customer made a single purchase of item 441, while on date 43n, the customer purchased 3 items 442-44n. In general, the screen of purchases may be limited to a time period, e.g., a year or may be all inclusive. Moreover, the associate 340 may scroll the screen down or up depending upon the size of the purchase history. Although only item and date are shown, the screen may include more or less detail including, a reason for purchase, such as, travel, work, gift, birthday, anniversary, and the like. Moreover, other details such as who the item was purchased for may also be provided. For example, for Son's birthday, self, home repair, and the like.

Referring now to FIG. 4C, a block diagram 450 of yet another level of the mobile device initiated concierge experience as viewed on computer device 420 is shown in accordance with an embodiment. For example, at diagram 450, the associate has selected a specific item 441 from the previous screen shown in diagram 430. This selection would open the present screen shown in diagram 450 which is a drill down into the specifics of item 441. In one embodiment, the specifics of item 441 can include style 451, size 452, price 453, related items 45n, and the like.

For example, the customer is at the store to purchase his daughter a pair of pants but is not sure of her size. The associate can drill down into a previous item 441 purchase and then pull up the size 452 information. In another example, the customer may have purchased her husband a pair of slacks and is interested in a matching shirt. Again, associate 340 drills down to the specific item 441 and then selects the related items 45n tab. This will provide a listing of related items. In general, the listing may include only items in the store, items available in the store or online, pictures of the listed items, and the like.

Thus, by utilizing the mobile device initiated concierge experience, a customer will likely feel valued as they receive personalized service. Moreover, the store will likely see customer loyalty as the store no longer becomes a faceless, hassle, stress induced location for the customer but instead a place where the customer feels a personal connection.

### Example Computer System Environment

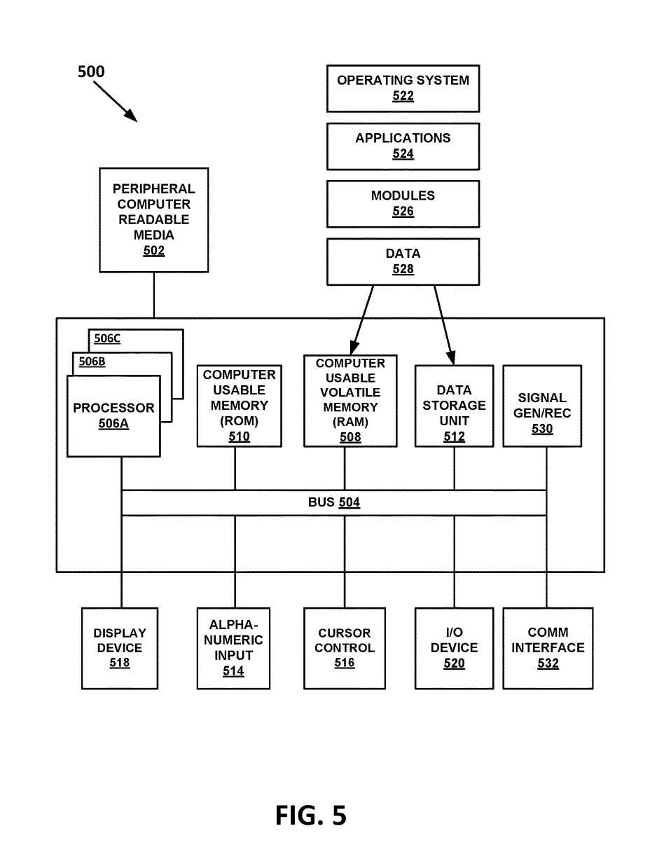

With reference now to FIG. 5, portions of the technology for providing a communication composed of computer-readable and computer-executable instructions that reside, for example, in non-transitory computer-readable storage media of a computer system. That is, FIG. 5 illustrates one example of a type of computer that can be used to implement embodiments of the present technology. FIG. 5 represents a system or components that may be used in conjunction with aspects of the present technology. In one embodiment, some or all of the components described herein may be combined with some or all of the components of FIG. 5 to practice the present technology.

FIG. 5 illustrates an example computer system 500 used in accordance with embodiments of the present technology. It is appreciated that system 500 of FIG. 5 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 5, computer system 500 of FIG. 5 is well adapted to having peripheral computer readable media 502 such as, for example, a disk, a compact disc, a flash drive, and the like coupled thereto.

Computer system 500 of FIG. 5 includes an address/data/control bus 504 for communicating information, and a processor 506A coupled to bus 504 for processing information and instructions. As depicted in FIG. 5, system 500 is also well suited to a multi-processor environment in which a plurality of processors 506A, 506B, and 506C are present. Conversely, system 500 is also well suited to having a single processor such as, for example, processor 506A. Processors 506A, 506B, and 506C may be any of various types of microprocessors. Computer system 500 also includes data storage features such as a computer usable volatile memory 508, e.g., random access memory (RAM), coupled to bus 504 for storing information and instructions for processors 506A, 506B, and 506C.

System 500 also includes computer usable non-volatile memory 510, e.g., read only memory (ROM), coupled to bus 504 for storing static information and instructions for processors 506A, 506B, and 506C. Also present in system 500 is a data storage unit 512 (e.g., a magnetic disk drive, optical disk drive, solid state drive (SSD), and the like) coupled to bus 504 for storing information and instructions. Computer system 500 also includes an optional alpha-numeric input device 514 including alphanumeric and function keys coupled to bus 504 for communicating information and command selections to processor 506A or processors 506A, 506B, and 506C. Computer system 500 also includes an optional cursor control device 516 coupled to bus 504 for communicating user input information and command selections to processor 506A or processors 506A, 506B, and 506C. Optional cursor control device may be a touch sensor, gesture recognition device, and the like. Computer system 500 of the present embodiment also includes an optional display device 518 coupled to bus 504 for displaying information.

Referring still to FIG. 5, optional display device 518 of FIG. 5 may be a liquid crystal device, cathode ray tube, OLED, plasma display device or other display device suitable for creating graphic images and alpha-numeric characters recognizable to a user. Optional cursor control device 516 allows the computer user to dynamically signal the movement of a visible symbol (cursor) on a display screen of display device 518. Many implementations of cursor control device 516 are known in the art including a trackball, mouse, touch pad, joystick, non-contact input, gesture recognition, voice commands, bio recognition, and the like. In addition, special keys on alpha-numeric input device 514 capable of signaling movement of a given direction or manner of displacement. Alternatively, it will be appreciated that a cursor can be directed and/or activated via input from alpha-numeric input device 514 using special keys and key sequence commands.

System 500 is also well suited to having a cursor directed by other means such as, for example, voice commands. Computer system 500 also includes an I/O device 520 for coupling system 500 with external entities. For example, in one embodiment, I/O device 520 is a modem for enabling wired or wireless communications between system 500 and an external network such as, but not limited to, the Internet or intranet. A more detailed discussion of the present technology is found below.

Referring still to FIG. 5, various other components are depicted for system 500. Specifically, when present, an operating system 522, applications 524, modules 526, and data 528 are shown as typically residing in one or some combination of computer usable volatile memory 508, e.g. random access memory (RAM), and data storage unit 512. However, it is appreciated that in some embodiments, operating system 522 may be stored in other locations such as on a network or on a flash drive; and that further, operating system 522 may be accessed from a remote location via, for example, a coupling to the internet. In one embodiment, the present technology, for example, is stored as an application 524 or module 526 in memory locations within RAM 508 and memory areas within data storage unit 512. The present technology may be applied to one or more elements of described system 500.

System 500 also includes one or more signal generating and receiving device(s) 530 coupled with bus 504 for enabling system 500 to interface with other electronic devices and computer systems. Signal generating and receiving device(s) 530 of the present embodiment may include wired serial adaptors, modems, and network adaptors, wireless modems, and wireless network adaptors, and other such communication technology. The signal generating and receiving device(s) 530 may work in conjunction with one or more communication interface(s) 532 for coupling information to and/or from system 500. Communication interface 532 may include a serial port, parallel port, Universal Serial Bus (USB), Ethernet port, Bluetooth, thunderbolt, near field communications port, WiFi, Cellular modem, or other input/output interface. Communication interface 532 may physically, electrically, optically, or wirelessly (e.g., via radio frequency) couple computer system 500 with another device, such as a mobile phone, radio, or computer system.

The computing system 500 is only one example of a suitable computing environment and is not intended to suggest any limitation as to the scope of use or functionality of the present technology. Neither should the computing environment be interpreted as having any dependency or requirement relating to any one or combination of components illustrated in the example computing system 500.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A method for providing a mobile device initiated concierge experience, the method comprising:
determining that a mobile device is within an area of interest;
interacting with said mobile device to determine an identifying characteristic;
searching a database for a customer profile related to said identifying characteristic; and
when the customer profile is identified, providing said customer profile to a store associate via a computer device, wherein said customer profile allows a store associate to identify a user of the mobile device and provide the user with a personalized shopping experience.

2. The method of claim 1 further comprising:
providing said customer profile to said store associate via said computer device selected from the group consisting of: a store associate's mobile device, a store's point of sale (POS) system, or a store's mobile device.

3. The method of claim 1 further comprising:
pinging the mobile device to determine that the mobile device is within an area of interest.

4. The method of claim 1 further comprising:
using a beacon to determine that the mobile device is within an area of interest.

5. The method of claim 1 further comprising:
providing a geo-fenced area at least at a portion of the area of interest; and
determining that the mobile device is within the area of interest when the mobile device enters into the geo-fenced area.

6. The method of claim 5 further comprising:
providing the geo-fenced area at a boundary about a store and a parking lot associated with the store.

7. The method of claim 1 wherein the identifying characteristic is selected from the group consisting of: a mobile device phone number, a mobile device identifier, a user's name, a user's store account number, a user's store rewards number, and a user identifier provided by an application operating on the mobile device.

8. A mobile device concierge system comprising:
a location determiner to determine that a mobile device is within an area of interest;
a device identifier to interact with said mobile device and obtain an identifying characteristic from said mobile device when a location of said mobile device is determined to be within said area of interest;
a customer profile obtainer to search a customer database for a customer profile associated with said identifying characteristic from said mobile device; and
when the customer profile is identified, a customer profile provider provides said customer profile to a store associate via a computer device, wherein said customer profile is utilized by a store associate to positively identify a user of the mobile device and provide the user with a personalized shopping experience.

9. The system of claim 8 wherein the location determiner is selected from the group consisting of: a pinging of the mobile device, a push interaction with a beacon, and a pull interaction with a beacon.

10. The system of claim 8 wherein the location determiner is selected from the group consisting of: a location broadcast from the mobile device, and a location broadcast from an app operating on the mobile device.

11. The system of claim 8 wherein the location determiner monitors a geo-fenced area and interacts with the mobile device after the mobile device enters into a geo-fenced area.

12. The system of claim 11 wherein a shopping incentive offer is broadcast to the mobile device after the mobile device enters into the geo-fenced area.

13. The system of claim 8 wherein the identifying characteristic from said mobile device is selected from the group consisting of: a phone number, a device identifier, a user's name, a user's store account number, a user's store rewards number, and a user identifier provided by an application operating on the mobile device.

14. The system of claim 8 wherein the customer profile includes customer information selected from the group consisting of: a user's picture, a user's description, a user's name, a user's store account number, a user's store rewards number, a purchase history, and an important date for the user.

15. The system of claim 8 wherein the customer profile includes customer information provided from sources in the group consisting of: a user's purchase history, an associate provided input, and a user provided input.

16. A method for providing a concierge experience, the method comprising:
utilizing a beacon, to monitor an area of interest for a mobile device;
determining with said beacon that a mobile device has entered the area of interest;
utilizing an identifying information from the mobile device to obtain a user profile related to a user of said mobile device; and
providing the user profile to a store associate via a store associate's mobile device, said store associate utilizing information in the user profile to identify said user and provide a personalized shopping experience to said user.

17. The method of claim 16 further comprising:
receiving a device identifier associated with a mobile device as the identifying information; and
utilizing the device identifier to search for the user profile related to the user.

18. The method of claim 16 further comprising:
deploying the beacon in a physical location within a retail store.

19. The method of claim 16 further comprising:
utilizing said beacon to establish a geo-fenced area about said area of interest, said geo-fenced area comprising:
at least a retail store; and
a parking lot associated with said retail store; and
providing a store visit incentive to the mobile device when a location of the mobile device is in said parking lot associated with said retail store.

20. The method of claim 19 wherein the store visit incentive is selected from the group consisting of: a text message, and a notification from a store's application operating on the mobile device.
